(19) United States
(12) Patent Application Publication
(10) Pub. No.: US 2017/0161519 A1
(43) Pub. Date: Jun. 8, 2017

(54) INFORMATION PROCESSING DEVICE, INFORMATION PROCESSING METHOD AND RECORDING MEDIUM

(71) Applicant: NEC CORPORATION, Tokyo (JP)

(72) Inventor: Tsubasa TAKAHASHI, Tokyo (JP)

(73) Assignee: NEC CORPORATION, Tokyo (JP)

(21) Appl. No.: 15/039,085

(22) PCT Filed: Nov. 18, 2014
(86) PCT No.: PCT/JP2014/005768

§ 371 Date: May 25, 2016

(30) Foreign Application Priority Data
Nov. 28, 2013 (JP) 2013-245637

(51) Int. Cl. G06F 21/62; G06F 19/00; G06F 17/30

(52) U.S. Cl. CPC G06F 21/6254; G06F 17/30598; G06F 17/30554; G06F 19/322

(57) ABSTRACT

Provided is an information processing device that can decrease ambiguity of relationship among attributes of linked data, to which relational diversification is performed, and can assess a common characteristic of a linked data group belonging to a cohort. The information processing device includes: relational diversification means that diversifies a relationship to make it difficult to identify a sensitive attribute value of the linked data from another sensitive attribute value; and anonymous cohort generating means which generates cohort information by extracting an attribute value or a characteristic and a property being common in a linked data group belonging to a cohort as a set of linked data assigned with a combination of same quasi-identifiers or a same group identifier and having similarity to one another, wherein the relational diversification means outputs the linked data group, of which a relationship is diversified, by adding the cohort information to the linked data group.

### TECHNICAL FIELD

The present invention relates to an anonymization technology for dealing with privacy information.

### BACKGROUND ART

With various services, privacy information relating to individuals is accumulated in an information processing device. Such privacy information includes, for example, personal purchase information and medical information.

For instance, a receipt, which is a detailed account for medical service fees, is accumulated in the information processing device as a data set constituted of records having attributes, such as date of birth, sex, name of illness, and drug name. In terms of privacy protection, such privacy information should not be open to the public or used as original information contents as is.

In this description, an attribute that possibly characterizes an individual and identifies the individual in combination with other factors, such as date of birth and sex, is referred to as quasi-identifier. Further, an attribute that is secret to other people, such as name of illness and drug name, is referred to as sensitive attribute (sensitive information: SA or sensitive value).

Privacy information includes linked (series) data that include a plurality of records assigned with the same unique identification information. Linked data that include sensitive attributes indicate a series of sensitive attributes. A receipt is linked data that list privacy information of different months. Further, a trajectory is time series data that list position information over time.

Such linked data including privacy information are highly beneficial data for secondary utilization unless there is a concern of privacy violation. Herein, the secondary utilization of privacy information means utilization of privacy information. In the secondary utilization, a third party other than a service provider that generates or accumulates privacy information, uses the privacy information in a third party service when the privacy information is provided to the third party, or, the service provider requests for outsourcing of analysis or other utilization of privacy information to the third party by the provider.

The secondary utilization of privacy information promotes analysis and research of the privacy information, which possibly enhances a service that uses results of the analysis and the research. Thus, when the privacy information is secondarily utilized, the third party other than the service provider that maintains the privacy information can be highly benefited from usefulness of the privacy information.

For example, a pharmaceutical company can be considered as the third party other than the service provider maintaining privacy information. The pharmaceutical company can analyze a co-occurrence relation, a correlation, and the like among drugs based on medical information. However, the pharmaceutical company can hardly acquire such medical information. If the pharmaceutical company can acquire medical information, the pharmaceutical company can know how drugs are used and further analyze use conditions of the drugs or the like.

However, a data set including such privacy information is not actively secondarily utilized over concern of privacy violation.

For example, it is assumed that a data set constituted of a user identifier (user ID) for uniquely identifying a service user and records including one or more pieces of sensitive information is accumulated in an information processing device of a service provider. In such a case, when sensitive information assigned with the user identifier is provided to a third party, the third party can identify a service user relating to the sensitive information by using the user identifier. That is, provision of sensitive information assigned with the user identifier to the third party leads to a risk of privacy violation.

Further, a case where one or more quasi-identifiers are assigned to each record in a data set constituted of a plurality of records is considered. In such a case, a certain individual may possibly be identified by a combination of quasi-identifiers. That is, even with a data set, from which a user identifier is removed, when a certain individual can be identified based on a combination of quasi-identifiers assigned to the data set, a risk of privacy violation is expected.

As a technique that converts a data set that includes privacy information with such characteristics to a privacy-preserving format while maintaining original usefulness of the privacy information, an anonymization technique is known.

NPL 1 suggests “k-anonymity” as the most well-known anonymity index. Further, a technique that causes a data set, as a subject of anonymization, to satisfy such k-anonymity is called “k-anonymization.” The k-anonymization converts subject quasi-identifiers so that at least k or more records with the same quasi-identifiers exist in a data set as a subject of anonymization.

As a method of conversion processing, methods such as generalization and truncation are known. Generalization is processing that converts original granular information to abstract information. Whereas, truncation is processing that removes the original granular information.

A related technique that utilizes such a k-anonymization technique is described in PTL1. PTL1 describes a related technique that stores data received from a user terminal after converting the data by encryption or the like, processes the restored data in a manner satisfying k-anonymity, and transmits the data to a server of a service provider.

NPL 2 suggests “1-diversity” as one of the anonymity indexes developed from k-anonymity. A technique that causes a data set, as a subject of anonymization, to satisfy such 1-diversity is called “1-diversification.” The 1-diversification converts a subject quasi-identifier so that a plurality of records having the same quasi-identifier include at least 1 or more kinds of different sensitive information.

Herein, the k-anonymization ensures that the number of records related to a quasi-identifier becomes k or more. The 1-diversification ensures that the number of kinds of sensitive information related to a quasi-identifier becomes 1 or more.

The above k-anonymization and 1-diversification do not take into account a correlation among different matters such as an order and a relationship among records (in other words, a characteristic, a transition, and a property; hereinafter referred to as “correlation” in the present application) when there are a plurality of records that have the same user identifier.

The related techniques described in the above-described NPL1 and NPL2 are techniques that perform k-anonymization for privacy information that does not constitute a series.

Further, an anonymization technique that anonymizes linked data, especially a trajectory, by abstracting attribute values is known.

NPL3 describes a technique that anonymizes a trajectory as time series data in which position information is listed over time. More specifically, the anonymization technique described in NPL 3 is an anonymization technique that ensures consistent k-anonymity of a trajectory by treating the start to end of the trajectory as a sequence.

The anonymization technique of a trajectory generates an anonymous trajectory of a tube shape that bundles k or more trajectories with geographical similarity. The anonymization technique of the trajectory generates an anonymous trajectory that maximizes the geographical similarity within a constraint of anonymity.

Further, a technique that anonymizes linked data by abstracting quasi-identifiers and abstracting a correlation (hereinafter, also simply referred to as “relationship”) among records in the linked data without abstracting sensitive attribute values is known.

NPL4 describes a technique relating to diversification of time series data (relational diversification). In the relational diversification, a group identifier that is common in unique identification information of a plurality of data subjects is assigned to each data instead of the unique identification information. A set of data subjects having the same group identifier is referred to as a cohort. A cohort is a group having a certain characteristic.

Further, the relational diversification processes quasi-identifiers of records with the same group identifier to have a common value. That is, identification of a record based on quasi-identifiers becomes difficult.

Such an operation precludes a record group of a particular data subject from being uniquely associated with the data subject. Further, abstracting a relationship (relational diversification) in a record group of a particular data subject makes it hard for a third party to identify other sensitive attribute values of a certain data subject even when the third party knows sensitive attribute values of some records of the same data subject.

### CITATION LIST

### Patent Literature

[PTL 1] Japanese Unexamined Patent Application Publication No. 2011-180839

### Non Patent Literature

[NPL1] L. Sweeney, “k-anonymity: a model for protecting privacy”, International Journal on Uncertainty, Fuzziness and Knowledge-based Systems, 10 (5), pp. 555-570, 2002.
[NPL2] K. LeFevre, D. DeWitt, and R. Ramakrishnan, “Mondrian Multidimensional k-Anonymity”, ICDE2006.
[NPL3] O. Abul, F. Bonchi, and M. Nanni, “Never Walk Alone: Uncertainty for Anonymity in Moving Objects Databases.” In Proceedings of 24th IEEE International Conference on Data Engineering, pp. 376-385, 2008.
[NPL 4] T. Takahashi, T. Takenouchi, and K. Sobataka, “Proposal of 1-diversification method for time series data” Proceedings of the 4th Forum on Data Engineering and Information Management, 2012.

### SUMMARY OF INVENTION

### Technical Problem

However, relational diversification makes it hard to recognize which records have a relationship in a record group that belongs to the same cohort. The reason for making the recognition difficult will be described below.

The relational diversification makes it difficult to uniquely identify a sensitive attribute value from another sensitive attribute value of a record of a certain data subject. That is, among sensitive attributes of a record group recorded in the same cohort, which sensitive attribute group is the sensitive attribute group of the same data subject becomes indistinctive. Thus, a correlation among sensitive attributes becomes ambiguous.

The following will describe a specific example where a correlation among sensitive attributes becomes ambiguous. FIG. 8 is an explanatory diagram illustrating an example of linked data. FIGS. 9 and 10 are explanatory diagrams illustrating another example of linked data.

The linked data illustrated in FIGS. 8 to 10 are constituted of ID, age, sex, year of medical treatment, and medical history. The ID is an identifier that specifies a patient as a data subject. The age and the sex are an age and a sex of a patient specified by the ID. The year of medical treatment is a year when a patient specified by the ID received a medical treatment. The medical history is a name of illness of a patient specified by the ID who received a medical treatment in the year of the medical treatment.

Further, FIG. 11 is an explanatory diagram illustrating an example of linked data after relational diversification is performed to the linked data illustrated in FIG. 8. FIGS. 12 and 13 are explanatory diagrams illustrating an example of linked data after relational diversification is performed to the linked data illustrated in FIGS. 9 and 10 respectively.

The linked data illustrated in FIGS. 11 to 13 are constituted of cohort ID, year of medical treatment, and medical history. The cohort ID is an ID that, when a cohort is formed to include linked data with high similarity from the linked data illustrated in FIGS. 8 to 10, specifies the cohort that is allocated to the linked data belonging to the formed cohort.

Herein, the linked data illustrated in FIGS. 11 to 13 do not include age and sex attributes included in the linked data illustrated in FIGS. 8 to 10. However, the age and sex attributes may be included in the relational-diversified linked data after processing the age and sex attributes or the like in a manner satisfying predetermined anonymity. Alternatively, the age and sex attributes may be stored in other linked data, and the other linked data may be made connectable with the linked data illustrated in FIGS. 11 to 13.

According to the linked data illustrated in FIGS. 8 and 9, a relationship of “type 2 diabetes (2 is expressed by a roman numeral in the drawings) and glaucoma” exists in the medical history attribute as a sensitive attribute of the data subject with ID “A.”

According to the relational-diversified linked data illustrated in FIGS. 11 and 12, the following four relationships are inferred as existing in the medical history attribute as a sensitive attribute in a record group with the cohort ID “1” including the data subject with ID “A.” The four relationships are relationships of “type 2 diabetes, glaucoma,” “hand, foot and mouth disease, glaucoma,” “type 2 diabetes, type 1 diabetes (1 is expressed by a roman numeral in the drawings),” and “hand, foot and mouth disease, type 1 diabetes.” The inferred relationships include “hand, foot and mouth disease, glaucoma” and “type 2 diabetes, type 1 diabetes” that do not actually exist.

Such relational diversification makes it hard to uniquely identify a certain sensitive attribute value that has a relationship with another sensitive attribute value.

Further, when trend analysis, tracking of conditions, and the like are performed for a group, a group of data subjects with a certain common characteristic may be extracted, and the trends and conditions of the group may be tracked. Such analysis is referred to as a cohort analysis. Examples of the cohort analysis include a causal relationship analysis, a side effect analysis, a medical follow-up, and the like. These cohort analyses require extraction of a cohort with a specific characteristic upon analysis.

In a data set to which the above-described relation diversification is performed, it is difficult to distinguish which data subject has which sensitive attribute value in a record group with a common group identifier. Further, it is also difficult to distinguish, in a cohort to which a record group with a common group identifier belongs, what kind of common characteristic the record group belonging to the cohort has. Further, it is still difficult to distinguish which records and which sensitive attribute values have relationships.

For example, from the linked data illustrated in FIGS. 8 and 9, it is recognized that the data subject with ID “A” and the data subject with ID “B” respectively have illness “type 2 diabetes” and “type 1 diabetes.” That is, the data subject with ID “A” and the data subject with ID “B” are commonly “diabetes” patients.

However, from the linked data illustrated in FIGS. 11 and 12 obtained by performing relational diversification to the linked data illustrated in FIGS. 8 and 9, a relationship of “type 2 diabetes, type 1 diabetes” is inferred as existing in a record group of cohort ID “1” that includes the data subject with ID “A” and the data subject with ID “B.” That is, it is difficult to distinguish whether the same patient successively has “type 2 diabetes” and “type 1 diabetes” or different patients respectively have “type 2 diabetes” and “type 1 diabetes.”

As such, the above-described relational diversification method obscures a relationship among sensitive attribute values, making the relationship among sensitive attribute values indistinctive. Further, it becomes also difficult to distinguish, in a cohort to which a record group with the same group identifier belongs, what kind of common characteristic the record group has.

That is, when relational diversification is performed to a linked data group, extraction of a predetermined cohort and understanding of characteristics of the cohort become difficult upon cohort analysis.

Thus, the objective of the present invention is to provide a technique of decreasing ambiguity of relationship among attributes of linked data, to which relational diversification is performed, and enabling understanding of a common characteristic of a linked data group belonging to a cohort.

### Solution to Problem

An information processing device according to an exemplary aspect of the present invention is an information processing device for linked data representing a series of record group of a same data subject. The information processing device includes:

relational diversification means that diversifies a relationship to make it difficult to identify a sensitive attribute value of the linked data from another sensitive attribute value; and

anonymous cohort generating means which generates cohort information by extracting an attribute value or a characteristic and a property being common in a linked data group belonging to a cohort as a set of linked data assigned with a combination of same quasi-identifiers or a same group identifier and having similarity to one another,

wherein the relational diversification means outputs the linked data group, of which a relationship is diversified, by adding the cohort information to the linked data group.

An information processing method according to an exemplary aspect of the present invention is an information processing method being executed in an information processing device for linked data representing a series of record group of a same data subject. The method includes:

by the information processing device,

diversifying a relationship to make it difficult to identify a sensitive attribute value of the linked data from another sensitive attribute value;

generating cohort information by extracting an attribute value or a characteristic and a property being common in a linked data group belonging to a cohort being a set of linked data assigned with a combination of same quasi-identifiers or a same group identifier and having similarity to one another; and

outputting the linked data group, of which a relationship is diversified, by adding the cohort information to the linked data group.

A non-transitory recording medium according to an exemplary n aspect of the present invention is a computer-readable non-transitory recording medium storing an information processing program executed in an information processing device for linked data representing a series of record group of a same data subject. The program causes the information processing device to execute:

relational diversification processing which diversifies a relationship to make it difficult to identify a sensitive attribute value of the linked data from another sensitive attribute value;

generation processing which generates cohort information by extracting an attribute value or a characteristic and a property being common in a linked data group belonging to a cohort being a set of linked data assigned with a combination of same quasi-identifiers or a same group identifier and having similarity to one another; and

output processing which outputs the linked data group, of which a relationship is diversified, by adding the cohort information to the linked data group.

### Advantageous Effects of Invention

According to the present invention, ambiguity of relationship among attributes of linked data, to which relational diversification is performed, can be decreased and a common characteristic of a linked data group belonging to a cohort can be understood.

### BRIEF DESCRIPTION OF DRAWINGS

FIG. 1 is a block diagram illustrating a configuration example of an information processing device according to an exemplary embodiment of the present invention;

FIG. 2 is a block diagram illustrating an example of an information processing device that uses a program;

FIG. 3 is an explanatory diagram illustrating a multiset extracted from attribute values of medical history attributes of linked data illustrated in FIGS. 8 to 10;

FIG. 4 is an explanatory diagram illustrating a multiset extracted from attribute values of medical history attributes of linked data illustrated in FIGS. 8 to 10;

FIG. 5 is an explanatory diagram illustrating an example of cohort information of linked data, to which relational diversification has done, illustrated in FIGS. 11 to 13;

FIG. 6 is a flowchart illustrating operation of anonymization processing and processing of generating auxiliary information by an information processing device;

FIG. 7 is a block diagram illustrating an overview of anonymization and auxiliary information generation device according to an exemplary embodiment of the present invention;

FIG. 8 is an explanatory diagram illustrating an example of linked data;

FIG. 9 is an explanatory diagram illustrating an example of linked data;

FIG. 10 is an explanatory diagram illustrating an example of linked data;

FIG. 11 is an explanatory diagram illustrating an example of linked data after relational diversification has done to the linked data illustrated in FIG. 8;

FIG. 12 is an explanatory diagram illustrating an example of linked data after relational diversification has done to the linked data illustrated in FIG. 9;

FIG. 13 is an explanatory diagram illustrating an example of linked data after relational diversification has done to the linked data illustrated in FIG. 10; and

FIG. 14 is a block diagram illustrating an example of a recording medium as an exemplary embodiment of the recording medium of the present invention.

### DESCRIPTION OF EMBODIMENTS

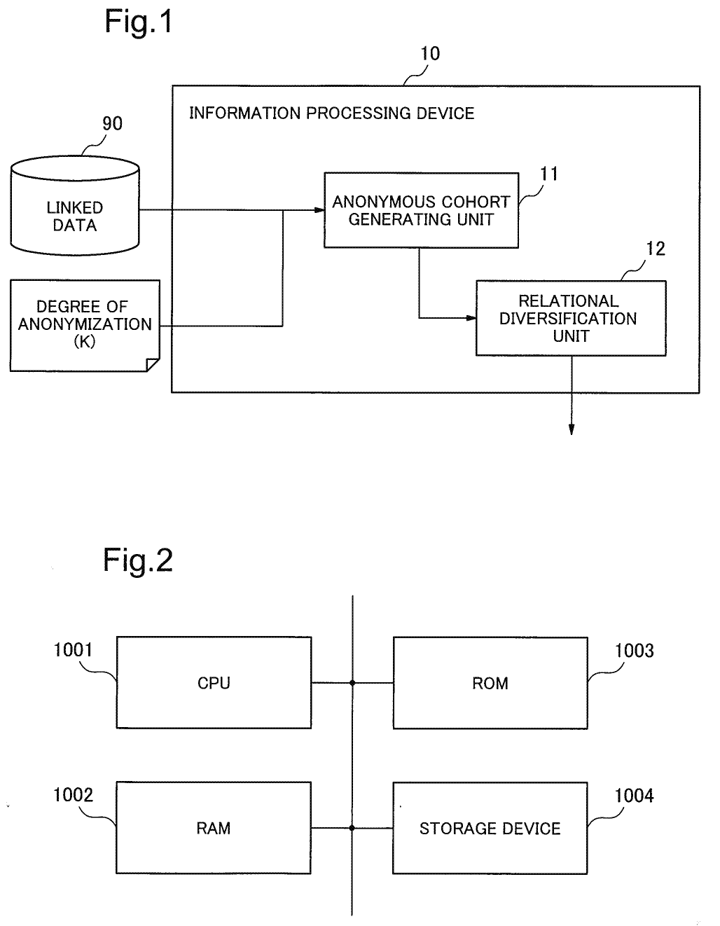

The following will describe the exemplary embodiment of the present invention with reference to the drawings. FIG. 1 is a block diagram illustrating a configuration example of information processing device 10. The information processing device 10 illustrated in FIG. 1 includes anonymous cohort generating unit 11 and relational diversification unit 12.

The information processing device 10 generates a cohort that satisfies predetermined anonymity with respect to linked data 90 as an anonymization subject. The information processing device 10 appends an attribute value or a characteristic and a property that are common in the linked data group belonging to the generated cohort and satisfy predetermined anonymity or have been processed to satisfy predetermined anonymity, as auxiliary information, to the relational-diversified linked data. Hereinafter, this auxiliary information is referred to as cohort information. Further, the processing of processing attribute values is referred to as recoding processing.

The data set as an anonymization subject includes sensitive attributes and the like that should not be favorably opened to the public or utilized as the original information content as is. Such a data set is constituted of a record group that has one or more attributes. Suppose at least one of the attributes of the record group can be categorized as sensitive attributes.

Here, the information processing device 10 can be configured by a computer device including a CPU (Central Processing Unit) 1001, a RAM (Random Access Memory) 1002, a ROM (Read Only Memory) 1003, and a storage device 1004, such as a hard disk, as illustrated in FIG. 2. FIG. 2 is a block diagram illustrating an example of an information processing device (a computer device) that uses a program.

In this case, the anonymous cohort generating unit 11 and relational diversification unit 12 are configured by the CPU 1001 that loads a computer program (also referred to as an information processing program) and a variety of data stored in the ROM 1003 or the storage device 1004 into the RAM 1002 and executes the same. Further, the linked data 90 that is a data set as an anonymization subject of the information processing device 10 may be, for example, stored in the storage device 1004. It should be noted that the information processing device 10 and a hardware configuration of the functional blocks of the information processing device 10 are not limited to the above configuration.

Next, each functional block of the information processing device 10 will be described.

The anonymous cohort generating unit 11 generates a cohort by grouping a linked data group so as to satisfy predetermined anonymity.

For example, the anonymous cohort generating unit 11 generates a cohort from a linked data group with high affinity by evaluating the affinity of attribute values in the linked data. In such a case, if k-anonymity is employed as anonymity to be satisfied, the anonymous cohort generating unit 11 inputs the degree of anonymity (for example, k) from outside and generates a cohort from k or more pieces of linked data.

Affinity of attribute values in linked data is evaluated by the similarity of the attribute values of two pieces of linked data.

As an example of a method of evaluating affinity of attribute values in linked data, the following will describe a method that is used for calculating similarity with respect to categorical sensitive attribute values. This method generates a multiset or a set of sensitive attribute values of records of linked data.

Then, frequency vectors are generated from the generated multiset or set.

Similarity among the generated frequency vectors are evaluated using cosine similarity. Cosine similarity is a measure of similarity between vectors for calculating similarity between vectors formed from two multisets based on the coincidence frequency of the elements forming the multisets. In evaluation using cosine similarity, two pieces of linked data with a larger number of sensitive attribute values co-occurring in the linked data is given higher similarity.

Further, if a conceptual tree (taxonomy) is provided relating to the attribute values to categorical attributes, distances and similarity may be evaluated by the number of edges among the attribute values in the conceptual tree or the like. Such an evaluation method can also be used for evaluation among quasi-identifiers.

An evaluation method used for calculating similarity of the numerical sensitive attribute values as subjects includes a method of evaluating the size of a difference of attribute values among records with the same time stamp and evaluating the size of the difference as similarity. Such an evaluation method can also be used for evaluation among quasi-identifiers.

Using the above-described and other evaluation methods, similarity between attributes of the linked data can be evaluated. Similarity between linked data may be derived by evaluating the above-described similarity between attributes for all the attributes or all the records included in the linked data and performing a variety of calculations such as adding, multiplying, weight averaging, averaging all the evaluated similarity. Alternatively, the similarity between linked data can be derived by a variety of calculations, such as adding, multiplying, weight averaging, averaging the evaluated similarity, of some attributes selected by a certain criteria.

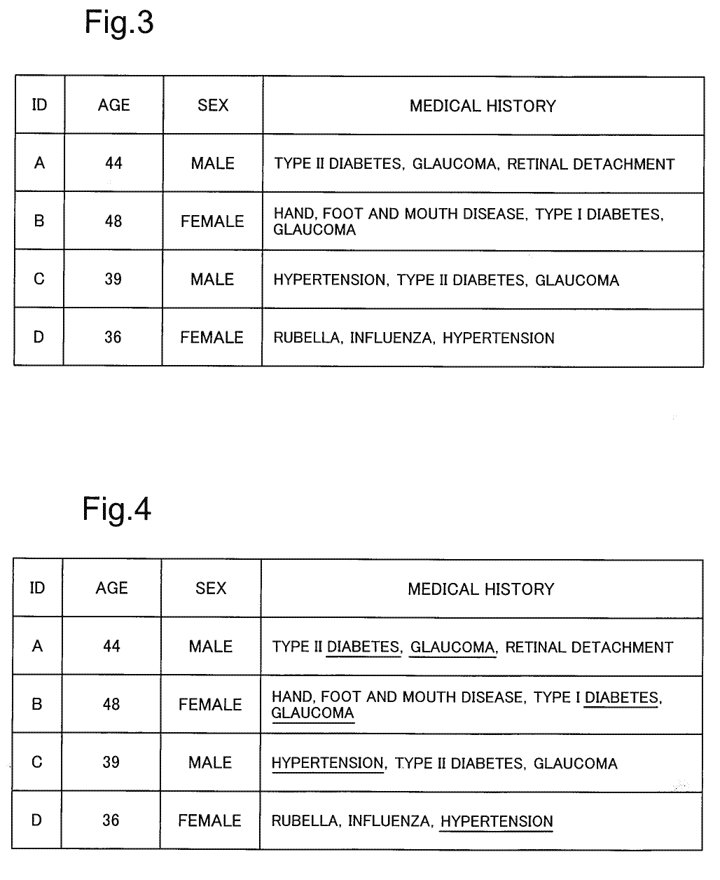

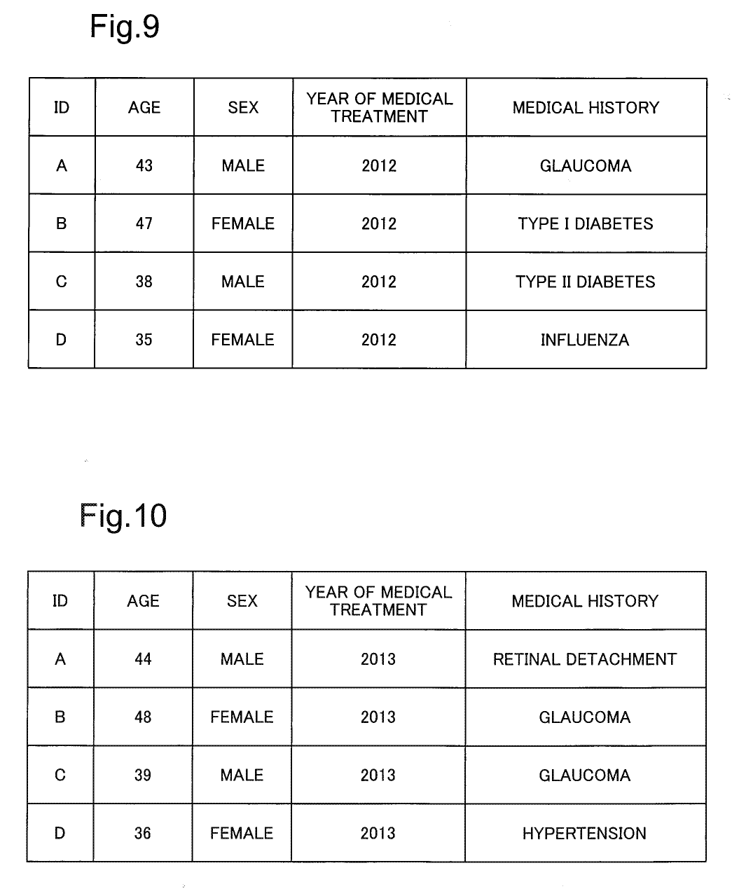

FIGS. 3 and 4 are explanatory diagrams illustrating a multiset extracted from attribute values of medical history attributes of the linked data illustrated in FIGS. 8 to 10. The multiset illustrated in FIGS. 3 and 4 is constituted of ID, age, sex, and medical history.

The multiset illustrated in FIGS. 3 and 4 is generated for each data subject with regard to medical history attributes. The medical history attribute includes all the medical history of a data subject included in each linked data illustrated in FIGS. 8 to 10 of the data subject.

According to the multiset illustrated in FIG. 3, similarity between elements of a multiset is high between an element of ID “A” and an element of ID “B” that commonly include “glaucoma” in medical history attributes, and between an element of ID “C” and an element of ID “D” that commonly include “hypertension” in medical history attributes.

As such, the anonymous cohort generating unit 11 generates a cohort that satisfies predetermined relational diversity from a set of linked data using similarity in linked data. The anonymous cohort generating unit 11 may use a method, such as, grouping and clustering of linked data by top-down approach when generating a cohort.

The following will describe an example of using top-down approach. The anonymous cohort generating unit 11 generates a cohort that includes all the linked data. Next, the anonymous cohort generating unit 11 divides the generated cohort into two or more cohorts by an arbitrary attribute. Here, the anonymous cohort generating unit 11 selects, for example, an attribute with the largest average value or sum of similarity of all the linked data as a reference attribute. Alternatively, the anonymous cohort generating unit 11 may use the size of entropy, the degree of ambiguity of relationships caused by relational diversification, or the like, as an index.

The anonymous cohort generating unit 11 divides the generated cohort into two or more cohorts by an arbitrary reference point of a reference attribute. The anonymous cohort generating unit 11 may use an arbitrary point, such as a median, an average value, a point where entropy becomes maximum or minimum, and a point where ambiguity of cohort information generated from the divided cohorts becomes small, as a reference point.

Further, the anonymous cohort generating unit 11 may cluster the linked data based on a reference attribute without determining a specific reference point. After dividing the cohort, the anonymous cohort generating unit 11 determines whether all the cohorts after division satisfy predetermined relational diversity. If all the cohorts after division satisfy predetermined relational diversity, the anonymous cohort generating unit 11 repeats this cohort division processing. If any one of the cohorts after division does not satisfy predetermined relational diversity, the anonymous cohort generating unit 11 cancels the division processing, returns the state of the cohort before division, and ends the cohort generation processing.

For example, if a cohort is generated based on the linked data illustrated in FIGS. 8 to 10, a cohort constituted of linked data of data subjects {A, B, C, D} is generated as an initial state. Next, when dividing a cohort with a medical history attribute as a reference, the anonymous cohort generating unit 11 divides a cohort constituted of linked data {A, B, C, D} into a cohort constituted of linked data {A, B} and a cohort constituted of linked data {C, D}. This division is a cohort division performed by clustering based on similarity of a multiset of medical history attributes.

Further, when dividing a cohort based on an age attribute, the anonymous cohort generating unit 11 divides a cohort constituted of linked data {A, B, C, D} into a cohort constituted of linked data {A, B} and a cohort constituted of linked data {C, D}. This division is a cohort division performed by extracting a median of age attributes of the linked data {A, B, C, D} and dividing the cohort into two cohorts based on a median. Here, the median of the age attributes of the linked data {A, B, C, D} is the age of B or C.

As such, the anonymous cohort generating unit 11 calculates similarity in linked data for all the combinations of linked data and creates a cohort from the linked data group with high similarity. Here, if k-anonymity is employed as anonymity to be satisfied, the anonymous cohort generating unit 11 makes each cohort include at least k pieces of linked data. The anonymous cohort generating unit 11 may perform a cohort generating operation by clustering using the above-described similarity.

It should be noted that, if a linked data group as the source of a cohort does not satisfy predetermined anonymity in the original state, the anonymous cohort generating unit 11 performs recoding processing for processing attribute values of the linked data to satisfy predetermined anonymity. Further, the anonymous cohort generating unit 11 also performs recoding processing when a predetermined reference number of or more attribute values and a predetermined reference amount or more information satisfy predetermined anonymity, yet, are not extracted from the linked data group as the source of the cohort.

Next, the anonymous cohort generating unit 11 extracts, for each cohort, an attribute value or characteristic, property, and the like that is common in the linked data group that belongs to the cohort. The anonymous cohort generating unit 11 writes the extracted common attribute value or characteristic and property in cohort information.

The anonymous cohort generating unit 11 extracts an attribute value that is common in the linked data group for each cohort. The anonymous cohort generating unit 11 extracts the common attribute value for each attribute of the linked data group. The common attribute value may be an attribute value that co-occurs at least once in the linked data.

In the record group of cohort ID “1,” “glaucoma” co-occurs in medical history attributes. Further, in the record group of cohort ID “2,” “hypertension” co-occurs in medical history attributes. The anonymous cohort generating unit 11 extracts co-occurring “glaucoma” and “hypertension” from respective cohorts.

Next, the anonymous cohort generating unit 11 generalizes attribute values and extracts a common attribute value from the generalized attribute values. That is, the anonymous cohort generating unit 11 generalizes the attribute values of linked data to a value that can be obtained by generalization to include attribute values of attributes of all the linked data belonging to the same cohort.

As such, if each record of the linked data has a different value in the same attribute, the anonymous cohort generating unit 11 may generate a representative value from the different values and generalize the attribute values based on the generated value. Alternatively, if each record of the linked data has a different value in the same attribute, the anonymous cohort generating unit 11 may generalize the attribute values to a value that includes all the different values, then, generate an attribute value that was generalized with other linked data.

The record group of cohort ID “1” has “diabetes” as a superordinate concept value that can be obtained by generalizing “type 2 diabetes” and “type 1 diabetes.” As an example of generalization of attribute values, the anonymous cohort generating unit 11 further extracts the superordinate concept value “diabetes” as a common attribute value of the linked data group that belongs to a cohort of cohort ID “1.” In FIG. 4, the attribute value extracted as a common attribute value of the linked data group that belongs to a cohort is indicated with an underlined text.

The common characteristic and property can be obtained by acquiring the characteristic and property for each linked data by arbitrary data analysis and extracting a characteristic and property that are common in all the linked data in a cohort from the acquired values, in the same way as the above-described extraction of common attribute values and generalization of the attribute values. Alternatively, the common characteristic and property can also be obtained by generalizing and extracting the characteristic and property of each linked data in the cohort.

As such, a cohort that satisfies k-anonymity and cohort information that satisfies k-anonymity relating to the cohort are generated.

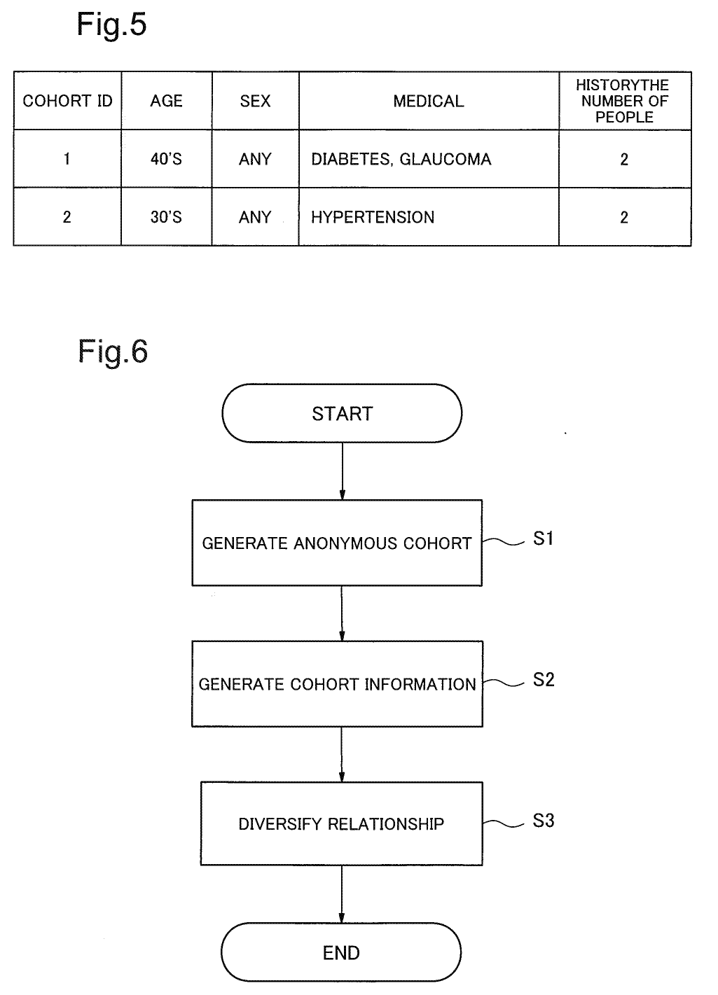

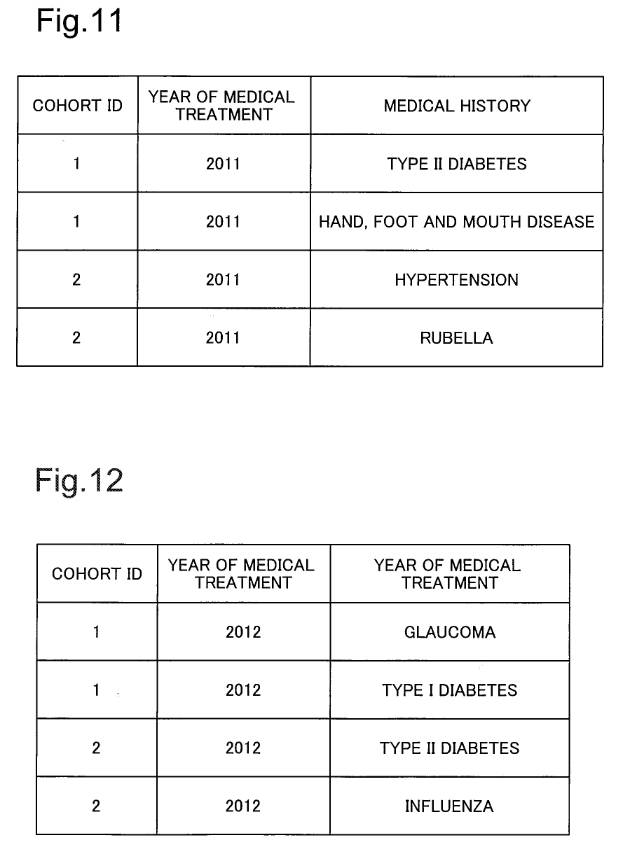

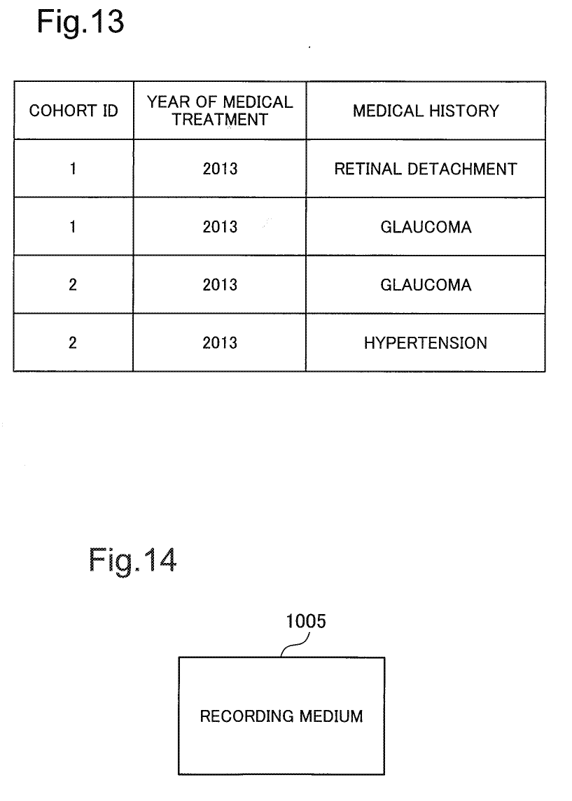

FIG. 5 illustrates an example of cohort information. FIG. 5 is an explanatory diagram illustrating an example of cohort information of linked data after relational diversification has done to the linked data as illustrated in FIGS. 11 to 13. The cohort information illustrated in FIG. 5 is constituted of cohort ID, age, sex, medical history, and the number of people.

The cohort ID is ID of a cohort that specifies a cohort relating to the cohort information. The medical history includes common information of medical history attributes for each cohort illustrated in FIG. 4. Likewise, the age and sex respectively include common information of age attributes and sex attributes of each cohort. The number of people is the number of data subjects relating to the linked data group belonging to a cohort specified by cohort ID.

Next, the relational diversification unit 12 diversifies relationships in linked data. The relational diversification unit 12 may use an existing relational diversification method when performing relational diversification. Such a method of performing relational diversification is omitted herein. The relational diversification unit 12 diversifies relationships in a linked data group belonging to a cohort generated by the anonymous cohort generating unit 11.

For example, if relational diversification has been performed for the linked data illustrated in FIGS. 8 to 10, relational-diversified linked data as illustrated in FIGS. 11 to 13 is generated. In the relational-diversified linked data, relationships among the attribute values in the linked data are ambiguous.

The relational diversification unit 12 outputs cohort information generated by the anonymous cohort generating unit 11, together with the relational-diversified linked data group.

The attribute value or the characteristic and property described in the cohort information are common characteristics in a linked data group in the cohort. Thus, it is understood that the cohort information is related to an arbitrary attribute value or characteristics in the linked data that belongs to the cohort. In addition, the cohort information can be used with less ambiguity.

The above has described procedures of generating a cohort that can satisfy relational diversity for linked data, of which relationships have not been diversified, then, performing relational diversification and generating cohort information. If there is linked data, of which relationships have been diversified, the information processing device 10 may generate a common attribute value, characteristic, or the like of the linked data using the cohort information generation function of the anonymous cohort generating unit 11. As such, the information processing device 10 may provide existing relational-diversified linked data in a state where some ambiguity among ambiguous attribute values is decreased.

As described above, the information processing device 10 publishes relational-diversified linked data with added auxiliary information, such as an attribute value or characteristic and property that are common in the linked data group belonging to a cohort, as well as, satisfy predetermined anonymity. As such, the information processing device 10 can provide relationships between relational-diversified sensitive attribute values in the linked data, to which auxiliary information is added, with less ambiguity than relationships between relational-diversified sensitive attribute values in the linked data, to which auxiliary information is not added.

The following will describe the operation of the information processing device 10 of the exemplary embodiment with reference to the flowchart of FIG. 6.

The anonymous cohort generating unit 11 extracts a linked data group that has a common attribute value or a processed common attribute value and satisfies predetermined anonymity from the linked data group (step S1).

Next, in certain cases, the anonymous cohort generating unit 11 processes attribute values of the linked data so as to satisfy predetermined anonymity (step S2). The certain cases include a case where a linked data group does not satisfy predetermined anonymity in the original state or a case where a predetermined reference number of or more attribute values or a predetermined reference amount of or more information satisfy predetermined anonymity yet are not extracted from the linked data group.

In process of step S2, the anonymous cohort generating unit 11 generates a cohort based on the extracted linked data group. Then, the anonymous cohort generating unit 11 extracts, for each cohort, an attribute value or a characteristic, property, or the like that is common for the linked data group belonging to the cohort, and writes the extracted common attribute value or characteristic and property in the cohort information.

Next, based on the cohort generated through step S1 and step S2, the relational diversification unit 12 diversifies relationships between sensitive attribute values in the linked data that belongs to the cohort (step S3). The relational diversification unit 12 outputs cohort information generated by the anonymous cohort generating unit 11, together with a linked data group, of which relationships have been diversified. After outputting the cohort information and linked data group, the information processing device 10 ends the operation.

The information processing device 10 of the exemplary embodiment generates the cohort information that is the attribute value or characteristic and property that are common in the linked data group, in a cohort and with satisfying predetermined anonymity, and then, outputs (publishes) the cohort information with the relational-diversified linked data group. As such, the information processing device 10 can provide some relationships between attributes of the linked data that have been made ambiguous by relational diversification, with less ambiguity. That is, since the relational-diversified linked data group is provided with the cohort information, a user can improve precision and decrease ambiguity upon cohort analysis.

Using the information processing device 10 of the exemplary embodiment, a user can recognize common characteristics of a linked data group that belongs to a cohort, since the characteristic attribute value that is common in the linked data group belonging to the cohort is added as auxiliary information to the relational-diversified linked data. Here, information provided as the auxiliary information is selected from the original linked data in a manner satisfying predetermined anonymity. Therefore, even if the auxiliary information is added to the relational-diversified linked data, predetermined anonymity can be maintained.

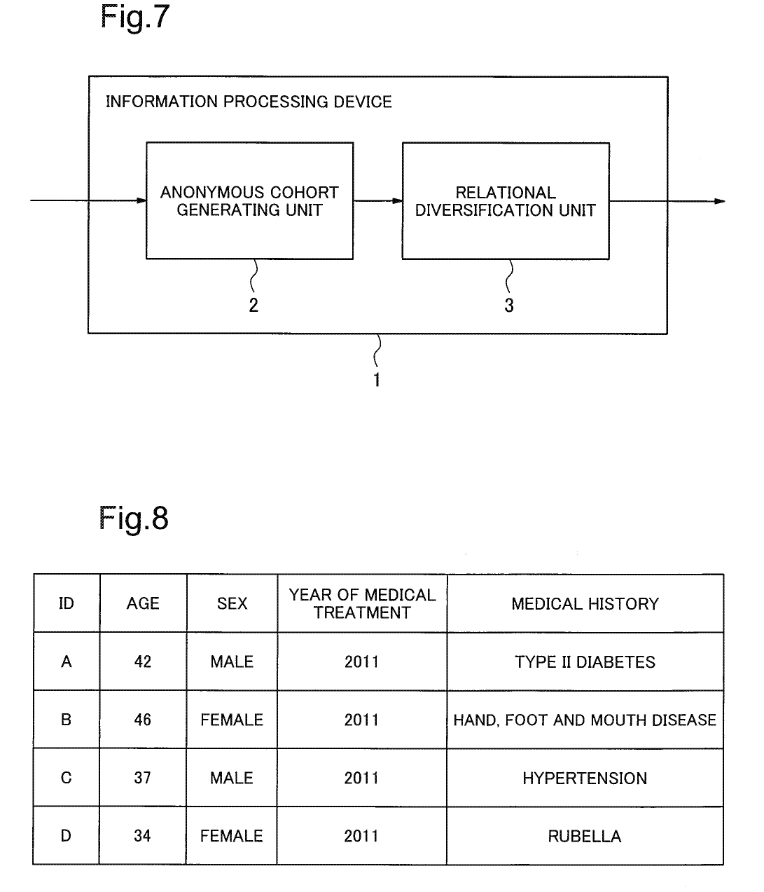

Next, an overview of the exemplary embodiment of the present invention will be described. FIG. 7 is a block diagram illustrating an overview of the information processing device 1 of the exemplary embodiment of the present invention. The information processing device 1 includes relational diversification unit 3 (such as relational diversification unit 12). The relational diversification unit 3 is a device for anonymizing linked data that represents a series of record group of the same data subject and generating auxiliary information of the linked data, where the relational diversification unit 3 performs relational diversification to make it hard to identify a sensitive attribute value of the linked data from another sensitive attribute value. Further, the information processing device 1 includes an anonymous cohort generating unit 2 (for example, anonymous cohort generating unit 11) that generates cohort information by extracting an attribute value or characteristic and property that are common in a linked data group belonging to a cohort that is a set of linked data that is assigned with a combination of the same quasi-identifiers or the same group identifier and has similarity to one another. Then, the relational diversification unit 3 of the information processing device 1 outputs a linked data group, of which relationships have been diversified, by adding the cohort information to the linked data group.

Having such a configuration, the information processing device 1 can lessen the ambiguity of relationships between attributes of linked data, of which relationships have been diversified, and recognize common characteristics of the linked data group that belongs to the cohort.

Further, the anonymous cohort generating unit 2 may generate a cohort from a plurality of linked data in a manner satisfying predetermined anonymity, and the relational diversification unit 3 may perform relational diversification for a linked data group that belongs to the cohort generated by the anonymous cohort generating unit 2.

Having such a configuration, the information processing device 1 can generate a cohort from a plurality of linked data and recognize common characteristics in the linked data group that belongs to the generated cohort.

Further, when extracting the common attribute value or characteristic and property of a linked data group, the anonymous cohort generating unit 2 may recode the linked data group so that the attribute value or the characteristic and property become a common value for the linked data group that belongs to a cohort.

Having such a configuration, the information processing device 1 can extract more attribute values or characteristics and properties that are common in a linked data group.

Further, the anonymous cohort generating unit 2 may generate a cohort in a manner in which similarity of a multiset that is generated from sensitive attributes based on the similarity of the sensitive attributes becomes high.

Having such a configuration, the information processing device 1 can generate a cohort based on sensitive attributes of a linked data group as the source of the cohort.

Further, the anonymous cohort generating unit 2 may generate a cohort in a manner in which similarity of a multiset that is generated from quasi-identifiers based on the similarity of the quasi-identifiers becomes high.

Having such a configuration, the information processing device 1 can generate a cohort based on quasi-identifiers of a linked data group as the source of the cohort.

Further, in the above-described exemplary embodiment, the operation of the information processing device described with reference to each flowchart can be stored in a storage device (a recording medium) of the information processing device (a computer device) as a computer program (an information processing program). Then, the computer program may be read and executed by the CPU 1001 illustrated in FIG. 2. In such a case, the present invention is configured by codes of the computer program or a storage medium.

FIG. 14 is a diagram illustrating an example of a recording medium 1005. The recording medium 1005 illustrated in FIG. 14 may be a computer-readable and non-transitory recording medium.

The claimed invention has been described so far with reference to the above-described exemplary embodiment, without limitation thereto. A variety of modifications that will be understood by those skilled in the art can be made to the configuration and details of the claimed invention within the scope thereof.

This application claims priority based on Japanese Patent Application No. 2013-245637 filed on Nov. 28, 2013, which application is incorporated herein in its entirety by disclosure.

### REFERENCE SIGNS LIST

1 Information processing device
2, 11 Anonymous cohort generating unit
3, 12 Relational diversification unit
10 Information processing device
90 Linked data
1001 CPU
1002 RAM
1003 ROM
1004 Storage device
1005 Recording medium

1. An information processing device for linked data representing a series of record group of a same data subject, the information processing device comprising:
relational diversification unit that diversifies a relationship to make it difficult to identify a sensitive attribute value of the linked data from another sensitive attribute value; and
anonymous cohort generating unit which generates cohort information by extracting an attribute value or a characteristic and a property being common in a linked data group belonging to a cohort as a set of linked data assigned with a combination of same quasi-identifiers or a same group identifier and having similarity to one another,
wherein the relational diversification unit outputs the linked data group, of which a relationship is diversified, by adding the cohort information to the linked data group.

2. The information processing device according to claim 1,
wherein the anonymous cohort generating unit generates a cohort from a plurality of linked data in a manner satisfying predetermined anonymity, and
the relational diversification unit diversifies a relationship in the linked data group belonging to the cohort generated by the anonymous cohort generating unit.

3. The information processing device according to claim 1,
wherein, when extracting an attribute value or a characteristic and a property being common in the linked data group, the anonymous cohort generating unit recodes a linked data group so that an attribute value or a characteristic and a property become a common value for the linked data group belonging to a cohort.

4. The information processing device according to claim 2,
wherein the anonymous cohort generating unit generates a cohort so that similarity of a multiset generated from a sensitive attribute based on similarity of the sensitive attribute becomes high.

5. The information processing device according to claim 2,
wherein the anonymous cohort generating unit generates a cohort so that similarity of a multiset generated from a quasi-identifier based on similarity of the quasi-identifier becomes high.

6. An information processing method being executed by an information processing device for linked data representing a series of record group of a same data subject, the method comprising:
diversifying a relationship to make it difficult to identify a sensitive attribute value of the linked data from another sensitive attribute value;
generating cohort information by extracting an attribute value or a characteristic and a property being common in a linked data group belonging to a cohort being a set of linked data assigned with a combination of same quasi-identifiers or a same group identifier and having similarity to one another; and
outputting the linked data group, of which a relationship is diversified, by adding the cohort information to the linked data group.

7. The information processing method according to claim 6, the method further comprising:
generating a cohort from a plurality of linked data in a manner satisfying predetermined anonymity; and
diversifying a relationship in a linked data group belonging to the generated cohort.

8. A computer-readable non-transitory recording medium storing an information processing program executed in an information processing device for linked data representing a series of record group of a same data subject, the program causing the information processing device to implement for:
diversifying a relationship to make it difficult to identify a sensitive attribute value of the linked data from another sensitive attribute value;
generating cohort information by extracting an attribute value or a characteristic and a property being common in a linked data group belonging to a cohort being a set of linked data assigned with a combination of same quasi-identifiers or a same group identifier and having similarity to one another; and
outputting the linked data group, of which a relationship is diversified, by adding the cohort information to the linked data group.

9. The non-transitory recording medium according to claim 8,
the program further comprising:
generating a cohort from a plurality of linked data in a manner satisfying predetermined anonymity, and
diversifying a relationship for a linked data group belonging to the generated cohort.

10. The information processing device according to claim 3,
wherein the anonymous cohort generating unit generates a cohort so that similarity of a multiset generated from a quasi-identifier based on similarity of the quasi-identifier becomes high.

11. The information processing device according to claim 3,
wherein the anonymous cohort generating unit generates a cohort so that similarity of a multiset generated from a quasi-identifier based on similarity of the quasi-identifier becomes high.

12. The information processing device according to claim 4,
wherein the anonymous cohort generating unit generates a cohort so that similarity of a multiset generated from a quasi-identifier based on similarity of the quasi-identifier becomes high.
